(19) United States
(12) Patent Application Publication
(10) Pub. No.: US 2009/0304276 A1
(43) Pub. Date: Dec. 10, 2009

(54) COLOR DEVIATION COMPENSATING APPARATUS AND METHOD, IMAGE PROCESSOR USING IT, RECORDED MEDIUM

(76) Inventor: Yo-Hwan Noh, Ansan-Si (KR)

Correspondence Address: BIRCH STEWART KOLASCH & BIRCH, PO BOX 747, FALLS CHURCH, VA, 22040-0747, US

(21) Appl. No.: 12/307,084

(22) PCT Filed: Aug. 10, 2007
(86) PCT No.: PCT/KR07/03849

§ 371 Date: Dec. 30, 2008

(30) Foreign Application Priority Data
Aug. 11, 2006 (KR) 10-2006-0076394

(51) Int. Cl. G06K 9/00

(52) U.S. Cl. 382/167

(57) ABSTRACT

Color deviation compensating apparatus and method of compensating distortion of captured image caused by lens of the image sensor. According to the one embodiment of the present invention comprises n image analyzer, configured to receive a reference image, divide the reference image into n regions, and perform sampling on data of at least one sampling pixel from each of the regions, wherein n is a natural number, and a mask generator, configured to generate a mask for compensation based on the sampling data from the image analyzer. All distortion such as white balance, irregular color deviation caused by micro lens of image sensor can be compensated.

### CROSS-REFERENCE TO RELATED APPLICATIONS

This application claims foreign priority benefits under 35 U.S.C. .sctn. 119(a)-(d) to PCT/KR2007/003849, filed Aug. 10, 2007, which is hereby incorporated by reference in its entirety.

### BACKGROUND

1. Technical Field

The present invention relates to an image sensor, more particularly, color deviation compensating apparatus and method of compensating distortion of captured image caused by lens of the image sensor.

2. Description of the Related Art

An image sensor is a semiconductor element which converts an optical image into an electric signal. A CCD (Charge coupled Device) is an element in which each of MOS (Metal-Oxide-Silicon) capacitors is very neighboring each other and charge carriers are stored in the capacitor transmitted. On the other hand, a CMOS (Complementary MOS) image sensor is an element which adopts a switching method of producing CMOS (Complementary MOS) transistors as many as the number of pixels and detecting output of the pixel successively by using CMOS technology which uses control circuits and signal processing circuits as peripheral circuits.

The portable devices (for example, digital cameras and mobile communication terminals) having an image sensor have been developed and are being sold. The image sensor is consisted of an array of small photosensitive diodes, called pixels or photosites. The pixels do not extract color form light but covert photons of a wide spectrum band into electrons. To record color images with a single sensor, the sensor filters each pixel to receive a different color. This type of sensors is known as a color filter array (CFA). The different color filters are arranged in a predetermined pattern across the sensor.

The most common pattern is a Bayer pattern which is widely employed in the CFA. Namely, a half of the total number of pixels is green (G), and each quarter of the total number is assigned to red (R) and blue (B), respectively. In order to obtain color information, red, green and blue filters are arranged in a particular sequence to form a repetitive pattern. The Bayer pattern is composed of a 2 x 2 array.

The Bayer pattern is based on the premise that the human eye extracts the most of luminance information from green floor of an image. Therefore, an image with high resolution can be generated when more of the pixels are made to be green, compared to when an equal number of red, green and blue pixels is alternated.

Although enlarging of a fill factor occupying a light detecting portion in the image sensor has been attempted in order to increase a light sensitivity of image sensor, there is a restriction on this attempt because its dimension is limited due to a logic circuit for signal processing. Thus in order to increase the sensitivity on an incident light, a micro lens is attached on each pixel of the image sensor and performs a color filtering for changing path of light entering onto the portion other than photo diode to be condensed on the portion of photo diode.

The distortion of the image occurs due to the structural or mechanical error caused by the micro lens on the entire pixels of the image sensor during the manufacturing process of image sensor, and this distortion may cause a fixed color deviation in all images captured by the image sensor.

Referring to FIG. 1, an example of color deviation of image having an improper white balance and an irregular pattern caused by the micro lens is shown. Assume that the family of red color is prominent on the left portion of image 11, and the family of blue color is prominent on the right portion of image 12. Namely, the conventional method of correcting on the type having a certain pattern is not suitable for non-uniformity of color occurred from the left to the right or from the top to the bottom or from the center to one side, not circular shape.

### SUMMARY

Accordingly, the present invention provides the color deviation compensating apparatus and the method thereof, the image processor using the method, and the recording medium, which compensates the all distortions such as white balance, irregular color deviation, etc., occurred by the micro lens of the image sensor.

Also, the present invention provides the color deviation compensating apparatus and the method thereof, the image processor using the method, and the recording medium, which compensates the color deviation irregularly and partly appearing on the entire image without a certain pattern.

To achieve aforementioned objects, according to one aspect of the present invention, a color deviation compensating apparatus is provided.

The color deviation compensating apparatus, comprises an image analyzer, which receives a reference image, divides the reference image into n regions, and performs sampling on data of at least one sampling pixel from each of the regions, wherein n is a natural number, and a mask generator, which generates a mask for compensation based on the sampling data from the image analyzer.

Preferably, the color deviation compensating apparatus may further comprise an image input device, which receives a captured image being captured by the image sensor, a mask applier, which applies the mask from the mask generator to the captured image, and an image output device, which outputs a compensated image which the mask is applied to. Here, the mask applier applies the mask after eliminating an offset from the mask or converting the mask with a predetermined compensation ratio.

Also, the image analyzer in the color deviation compensating apparatus may select at least one pixel among pixels locating on the boundary of each of the regions as the sampling pixel.

Also, the mask generator in the color deviation compensating apparatus may determine the mask value of pixels in each of the regions based on a locational relationship with the sampling pixels

Also, the image analyzer in the color deviation compensating apparatus may divide each of the regions by block of a rectangular shape and select pixels corresponding to vortex of the block as sampling pixels. Here, which the mask generator may apply weights on pixels in the block based on distances from each of the vortexes of the block to determine the mask value.

Also, the data of sampling pixels is RGB data of the pixels, and the mask value is obtained from inverting the RGB data. Here, the data of the sampling pixels is RGB data in one of red (R), green (G), and blue (B) channels.

And, the data of the sampling pixels is a deviation for RGB data of a reference pixel.

To achieve aforementioned objects, according to another aspect of the present invention, an image processor of compensating color deviation caused by an image sensor.

The image processor a color deviation compensator, which divides a reference image into n regions, performs sampling on data of at least one sampling pixel from each of the regions, generates a mask for compensating a captured image based on the sampling data, and generates a compensated image by applying the mask to the captured image, wherein n is a natural number, and a backend processor, which processes the compensated image from the color deviation compensator to be displayed.

Here, the image processor may further comprises an interpolator, which performs a color interpolation process on the reference image and generate images of each channel of red, green, and blue to provide to the color deviation compensator.

The color deviation compensator comprises an image input device, which receives a captured image being captured by an image sensor, an image analyzer, which receives the reference image, divides the reference image into n regions, and performs sampling on data of at least one sampling pixel from each of the regions, a mask generator, which generates the mask for compensation based on the sampling data from the image analyzer, a mask applier, applies the mask from the mask generator to the captured image, and a compensated image output device, which outputs the compensated image where the mask is applied to.

Preferably, the image analyzer in the image processor may select at least one pixel among pixels locating on the boundary of each of the regions as the sampling pixel.

Also, the mask generator in the image processor may determine the mask value of pixels in each of the regions based on a locational relationship with the sampling pixels.

Also, the image analyzer in the image processor may divide each of the regions by block of a rectangular shape and select pixels corresponding to vortex of the block as sampling pixels. Here, the mask generator may apply weights on pixels in the block based on distances from each of the vortexes of the block to determine the mask value.

Also, the data of sampling pixels is RGB data of the pixels, and the mask value is obtained from inverting the RGB data. Here, the data of the sampling pixels is RGB data in one of red (R), green (G), and blue (B) channels.

And, the data of the sampling pixels is a deviation for RGB data of a reference pixel.

Also, the mask applier in the image processor may apply the mask after eliminating an offset from the mask or converting the mask with a predetermined compensation ratio.

To achieve aforementioned objects, according to still another aspect of the present invention, a method of compensating color deviation caused by an image sensor is provided.

The method of compensating color deviation comprises (a) obtaining a reference image, (b) dividing the reference image into n regions, wherein n is a natural number, (c) selecting data of sampling pixels being selected from each the regions according to a predetermined condition, and (d) generating a mask based on the data of the selected sampling pixels.

Preferably, (e) obtaining a compensated image that is generated by applying the mask to a captured image may be further comprised.

Also, the step (c) selects sampling pixels among pixels locating on the boundary of each of the regions.

Also, the step (d) comprises (d-1) inverting the data of the sampling pixel, and (d-2) generating a mask value of all pixels in the region based on the inverted value according to a distance from the sampling pixel.

Also, the step (d) comprises (d-1) generating pixels data of all pixels in the region based on the data of sampling pixel according to a distance from the sampling pixel, and (d-2) inverting the pixel data to obtain a mask value.

Also, the step (d) divides each of the regions by block of a rectangular shape and the step (c) selects pixels corresponding to vortex of the block as sampling pixels.

Also, the step (d) apply weights on pixels in the block based on distances from each of the vortexes of the block to determine the mask value.

To achieve aforementioned objects, according to still another aspect of the present invention, in order to compensate the lens distortion (irregular color deviation, luminance difference between the center and the circumference, etc), a computer-readable medium including a program containing computer-executable instructions is provided.

Other objectives, advantages, and novel features of the present invention will become more apparent through the following description in reference to the accompanying drawings and embodiments.

### BRIEF DESCRIPTION OF THE DRAWINGS

FIG. 1 shows an example of color deviation of an image having an improper white balance and an irregular pattern caused by the micro lens.

FIG. 2 shows a block diagram of an image device according to one embodiment of the present invention.

FIG. 3 shows a block diagram of a color deviation compensating apparatus according to one embodiment of the present invention.

FIGS. 4 and 5 illustrate one region being divided by one embodiment of the present invention, the sampling pixel from the region, and the method of obtaining the mask values of the pixels in the region.

FIG. 6 shows the reference image, mask, and the compensated image according to one embodiment of the present invention.

FIG. 7 is a flowchart showing the method of compensating color deviation according to one embodiment of the present invention.

### DETAILED DESCRIPTION

Hereinafter, with reference to the accompanying drawings, the embodiments of the color deviation compensating apparatus and the method, the image processor using it, and the recording medium will be described. In describing the present invention, the description of the related well-known arts may be omitted if they made the substance of the present invention obscure. The ordinal numeral (e.g., the first, the second, etc.) being used in the detailed description is just an identifier for distinguishing the same or equivalent elements orderly.

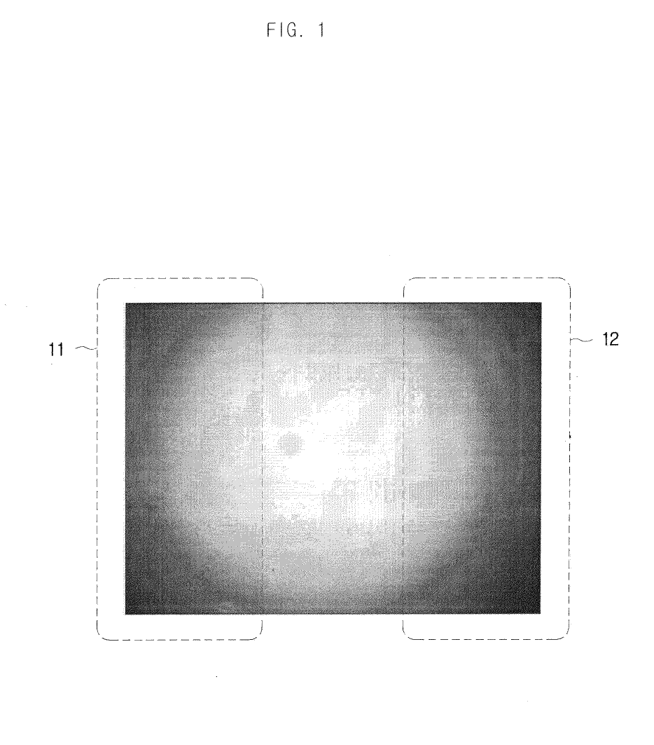

The image shown in FIG. 1 will be used as an example of image having the irregular color deviation to be compensated.

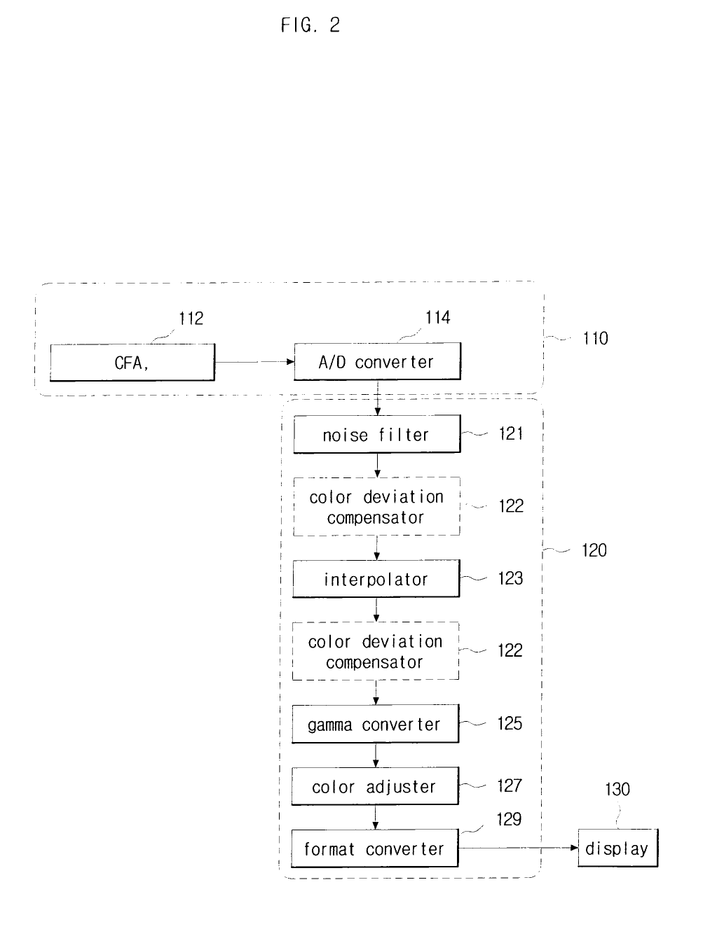

FIG. 2 is a block diagram of an image device according to the one embodiment of the present invention. The image device 100 comprises a sensor 110, an image processor 120, and a display 130. Of course, a key button, a memory, and so on may be further comprised, however, they are irrelevant to the substance of the present invention so the description on them will be omitted.

The sensor 110 comprises a color filter array (CFA) 112 and an Analog to Digital (A/D) converter 114. Of course, the sensor 110 may further comprise an external lens (not shown).

The CFA 112 converts an optical subject signal into an electric signal. Here, it is possible for CFA 112 to use various patterns such as Bayer pattern, etc., and each pixel generates an image signal having information on color of red, green, or blue. Pixel corresponding to red (R) pattern outputs image signal just having red data, pixel corresponding to green (G) pattern outputs image signal just having green data, and pixel corresponding to blue (B) pattern outputs image signal just having blue data. In the CFA 112 with Bayer pattern, complete color data can be acquired through an interpolation process (e.g., deducing deficient color data of a pixel from calculating the mean of left and right pixels' values, or the mean of top, bottom, left, and right pixels' values) on image signals of each pixel by color. The interpolation process is performed by an interpolator 123 of the image processor 120.

The A/D converter 114 converts the image signals being coverted by the CFA 112 into digital signals to be sent to the image processor 120.

The image processor 120 comprises the interpolator 123, a gamma converter 125, a color adjuster 127, a format converter 129, and a color deviation compensator 122. A noise filter 121 may be further comprised. In addition the image processor 120 may further comprise a timing generator (not shown) that generates various timing signals by using a horizontal synchronization signal (Hsync), a vertical synchronization signal (Vsync), and a pixel clock signal (PCLK), all being used for operating the CFA 112.

The noise filter 121 filters off the noise included in the digital signal from the A/D converter 114. The noise filter 121 may be included in the image processor 120.

The interpolator 123 generates pixel signals of red, green, and blue for each of pixels. In case that the image signals from CFA 112 have Bayer pattern, it is not possible to acquire pixel signal of green (G) or blue (B) from the pixel corresponding to red (R). Thus the interpolator 123 can generate the pixel signal of green (G) or blue (B) from the pixel having only pixel signal of red (R) through the interpolation process by using signals from neighboring pixels. For this, with an interpolation memory (not shown) for temporarily storing pixel signals of neighboring pixels, and the interpolator 123 performs the interpolation process by using the pixel signals stored temporarily on the interpolation memory.

The gamma converter 125 tunes image data suitable to device characteristics (gamma characteristics) of the display 130 for displaying image on the display 130 (e.g., LCD, CRT, etc). The gamma table (not shown) is equipped in advance, and stores values for being converted into the gamma characteristics of image output device of the display 130.

The color adjuster 127 is for tuning up the color tones (e.g., bluish color). And the format converter 129 is for converting the pixel signal into a format of image signal suitable to the display 130. Pixel signal is converted into NTSC format or a digital components format such as YUV or YCbCr. The format converter 129 may have a format conversion table (not shown) for converting into a display signal format such as NTSC or YV.

The color deviation compensator 122 outputs a compensated image, in which irregular patterns and uneven color deviations in an image inputted, that is photographed, through the sensor are compensated. The color deviation compensator 122 can be connected either to the front or end of the interpolator, as shown in FIG. 2.

1) case of the color deviation compensator 122 connected to the front of the interpolator 123

According to the characteristics of Bayer pattern, every pixel of captured image has the pixel signal of one color out of red, green, and blue, not all of them. Thus, color deviation compensator 122 compensates all color deviations caused by the micro lens only by pixel data (RGB data) regardless of channels of each color. In this compensation, there is no classification on red, green, or blue, and same compensation is applied to all of them.

2) case of being connected to the end of interpolator 123

Every pixel of captured image has pixel signal of red, green, and blue after interpolation process. Thus color deviation compensator 122 compensates the color deviation per each channel by use of pixel data (RGB data) of each channel. In this compensation, the color deviation compensation may be varied per red, green, and blue.

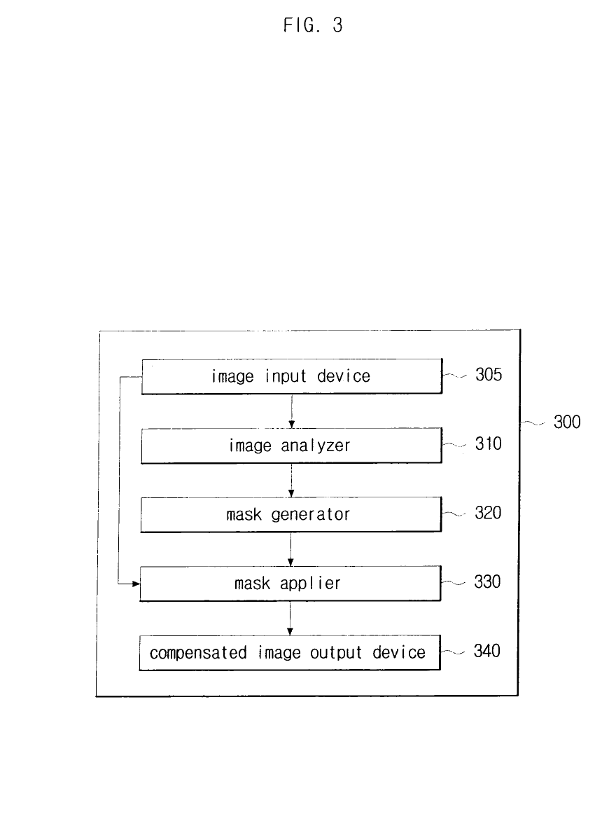

The configuration of color deviation compensator 122, the principal and the method of color deviation compensation will be described in detail with reference to FIG. 3.

FIG. 3 shows block diagram of a color deviation compensating apparatus according to one embodiment of the present invention. The color deviation compensating apparatus is equivalent to the color deviation compensator in the image processor 120.

The color deviation compensating apparatus 300 comprises an image analyzer 310 and a mask generator 320. An image input device 305, a mask applier 330, and a compensated image output device 340 may be further comprised.

The image analyzer 310 receives as an input a reference image captured under a certain condition for generating a mask. It is preferable that the reference image is captured under a white light.

The image analyzer 310 performs an analysis to determine the characteristics of the sensor 110 or the lens (not shown) by use of the reference image. The analysis is performed by the following order.

Firstly, the reference image is divided into n (n is natural number) regions. It is preferable that each region should not be overlapped. n regions may have same shape or different shapes.

And in order to produce data (e.g., RGB data) of pixels in the region, more than one sampling pixel in each region is selected to produce the data. Here, it is preferable that the sampling pixel locates on the boundary of each region. For example, where the region is in a rectangular shape, pixel on each vertex or on the central point of each edge can be the sampling pixel.

Additionally, when the sampling pixels are selected and data of each sampling pixels is produced, it is possible to produce data by considering the locational relationship (e.g., distance) between the sampling pixel and other pixels in the region. Namely, the locational relationship between a certain pixel and the sampling pixels in the region is compared. It is possible to determine data of certain pixel by assigning more weight on the sampling pixel near to the certain pixel and less weight on the sampling pixel far from the certain pixel.

The mask generator 320 generates a mask for compensating a distortion caused by the sensor 110 or the lens based on-the data of sampling pixel being analyzed by the image analyzer 310. The mask is composed of inverted value of pixel data.

The mask generator 320 generates the mask by use of data of sampling pixels only or data of all pixels in the reference image. It is possible, as described above, to obtain the data of all pixels in the reference image by additionally generating data of other pixels based on the sampling pixel data in the image analyzer 310. By inverting all pixel data of the reference image, the fundamental first mask value for each pixel can be obtained and the mask can be generated.

But, if the mask generator 320 obtained just data of sampling pixel from the image analyzer 310, the mask generator 320 generates the inverted value that is made from inverting data of sampling pixel. And it is possible to produce the mask value according to the distance between other pixels in the region and the sampling pixels based on the inverted value of each of sampling pixels. Namely, the distances between a certain pixel and the sampling pixels are compared to. It is possible to determine the mask value of the certain pixel by assigning more weight on the inverted value of sampling pixel near to the certain pixel and less weight on the inverted value of sampling pixel far from the certain pixel. By inverting data of all pixels of the reference image, the fundamental first mask value for each pixel can be obtained and the mask can be generated.

The color deviation compensating apparatus according to another embodiment of the present invention further comprises the image input 305, the mask applier 330, and the compensated image output device 340.

The image input device 305 receives from the image sensor the captured image to where the mask being generated by the mask generator 320 is applied. The aforementioned reference image can be also received from the image input device 305, and provided to the image analyzer 310.

The mask applier 330 receives the captured image from the image input device 305, and obtains the compensated image of which color deviation is compensated by applying the mask being generated by the mask generator 320 to the captured image. The compensated image can be generated by adding a certain ratio of the captured image to the captured image by performing a reciprocal multiplication, division, addition, etc., in order to apply the mask to the captured image.

Here, the degree of color deviation is measured in the mask being generated by the reference image. Since the reference image made by the white light does not have all values within the resolution of the image sensor (e.g., if the resolution is 10 bits, it does not have all values from 0 to 1023), so a proper compensation is needed.

Thus, the mask applier 330. may comprise a mask image level downer (not shown), which if there is an offset in the mask being generated by the mask generator 320, downs to 0 (zero) level by eliminating offset to make the mask to be used as a gain, and a mask image gain applier (not shown), which multiplies gain to the mask image to make the mask to be practically applicable. Here, 0 level means, for example, if the resolution is 10 bits and the luminance value will be one of 0 to 1023, to comprise 0 (zero), the smallest value (i.e., the darkest luminance value) among these values.

In addition, the mask applier 330 may further comprise a mask converter (not shown), which converts the mask value of mask in the form of a compensation ratio or coverts and recognizes a prime number operation value.

In addition, the mask applier 330 may further comprise an operation overflow limiter (not shown), which sets limit on an overflow of data or an underflow, both occur due to the various operations during applying the mask to the captured image. The overflow of data is an excessive output due to the input of number larger than the largest number that can be displayed during computer operation, and it may cause the operation suspended. Also, the underflow occurs when the smaller integer than the smallest integer that can be displayed during computer operation is inputted.

The compensated image output device 340 outputs at back end the compensated image where the mask is applied to by the mask applier 340.

In the present invention, the data of sampling pixels that the image analyzer 310 performs sampling is RGB data. Alternatively, it is also possible to perform the sampling of the deviation of RGB data of sampling pixel based on the RGB data of reference pixel.

Also, in the present invention, after obtaining the mask value by inverting the data of sampling pixel, as described above, the mask is formed from varying weights based on the distances for the inverted values of sampling pixels to obtain the mask values of all pixels. Alternatively, it is also possible to form the mask from obtaining data of all pixels by varying weights based on the distances for the data of sampling pixels, and inverting the obtained data to obtain the mask value.

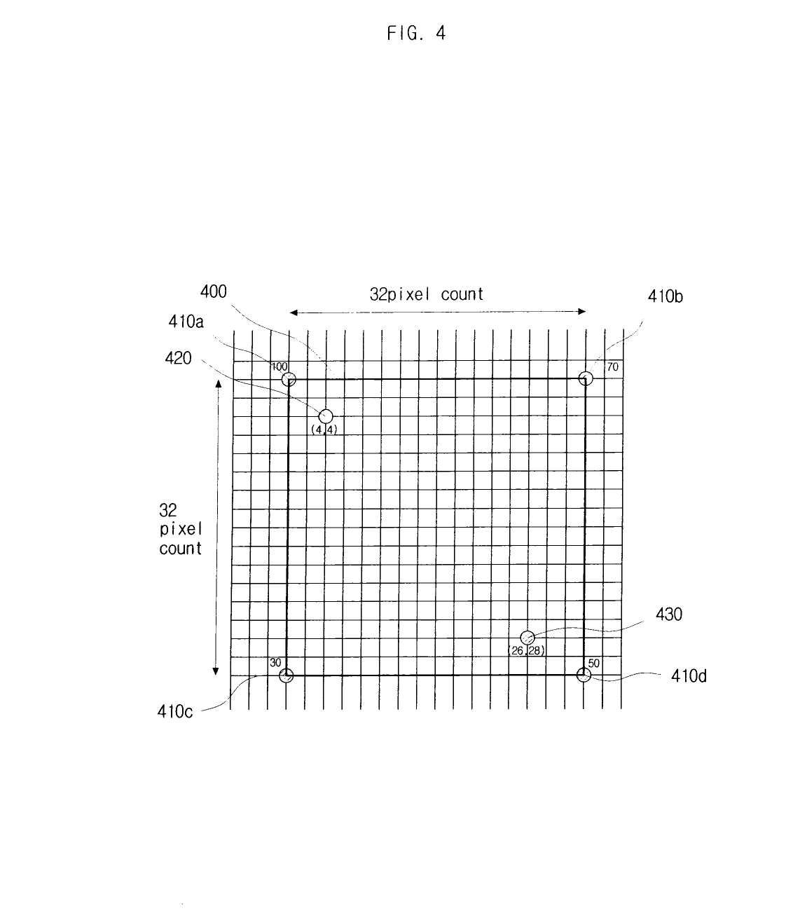

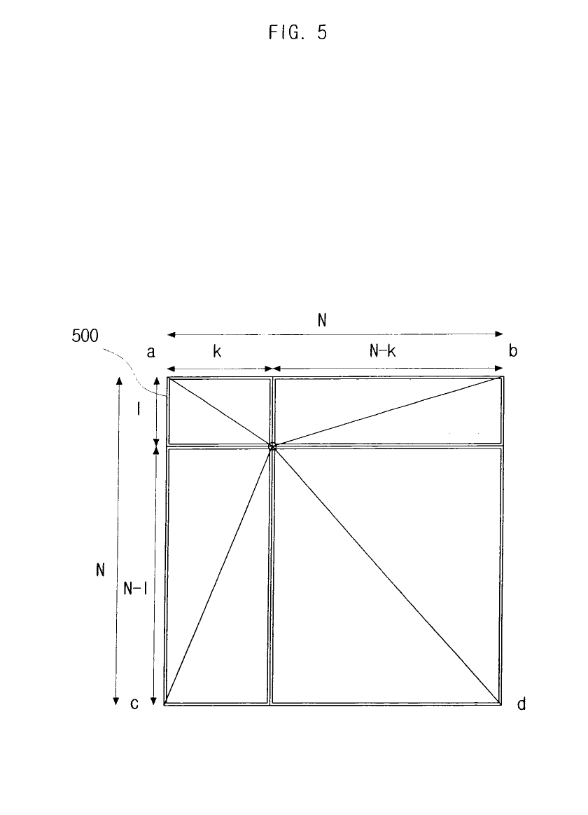

FIGS. 4 and 5 illustrate one region being divided by the one embodiment of the present invention, the sampling pixel from the region, and the method of obtaining the mask values of the pixels in the region.

Referring to FIG. 4, the region divided by the image analyzer 310 has the square shape of 32×32 pixels. This is only an example for description so it is apparent to those who skilled in the art that the shape or size of the region may be varied.

Assume that sampling data from each of vertexes 410a, 410b, 410c, 410d on the region are 100, 70, 30, 50. In this case, the method of generating the mask value of a certain pixel, not the sampling pixel, within the region 400 is as follows. Hereinafter, assume that the first vertex 410a in the region 400 locates at (0, 0).

Data of the first pixel 420 locating at (4, 4) is generated by the following Formula 1, and data of the second pixel 430 locating at (26, 28) is generated by the following Formula 2.

1/1024×{100×(32−4)×(32−4)+70×(4)×(32−4)+30×(32−4)×(4)+50×(4)×(4)} [Formula 1]

1/1024×{100×(32−26)×(32−28)+70×(26)×(32−28)+30×(32−26)×(28)+50×(26)×(28)} [Formula 2]

This is one example of calculation after weighting on the distance between the pixel of which data is to be generated and the obtained sampling pixel

Referring to FIG. 5, the data calculation of a certain pixel locating at (k, 1) within N×N size region 500 can be generally expressed as Formula 3.

1/N²×{a×(N−k)×(N−1)+b×(k)×(N−1)+c×(N−k)×(1)+d×(k)×(1)} [Formula 3]

Where, (a, b, c, d) is data at four vortexes of N×N size region 500. In the above Formula 3, data of sampling pixel near to the pixel of which data is to be generated is reflected much, and data of sampling pixel far from the pixel is reflected less.

Also, in another embodiment of the present invention, when dividing the reference image into n regions and selecting sampling pixel by the image analyzer 310, if the sampling pixels from each region having same size of rectangular shape are selected from vortexes of each rectangular shape, the selection of sampling pixel and data calculation of sampling pixel can be performed by a reduction scaling on the reference image. When the sampling pixels locate as described above, since the locations are arranged regularly so the sampling pixels are selected just by the reduction scaling, it is advantageous to obtain data with ease.

Also, the image analyzer 310 of the present invention may perform a blurring on the reference image before performing the sampling by selecting sampling pixels from the reference image. Since the sampling pixel may also have noise, the blurring is performed on the reference image entirely. Alternatively, in selecting the sampling pixels, the effect of blurring can be achieved by the method which calculates the mean of pixel data within a certain region centered on the selected sampling pixel and obtains the mean as data of the sampling pixel.

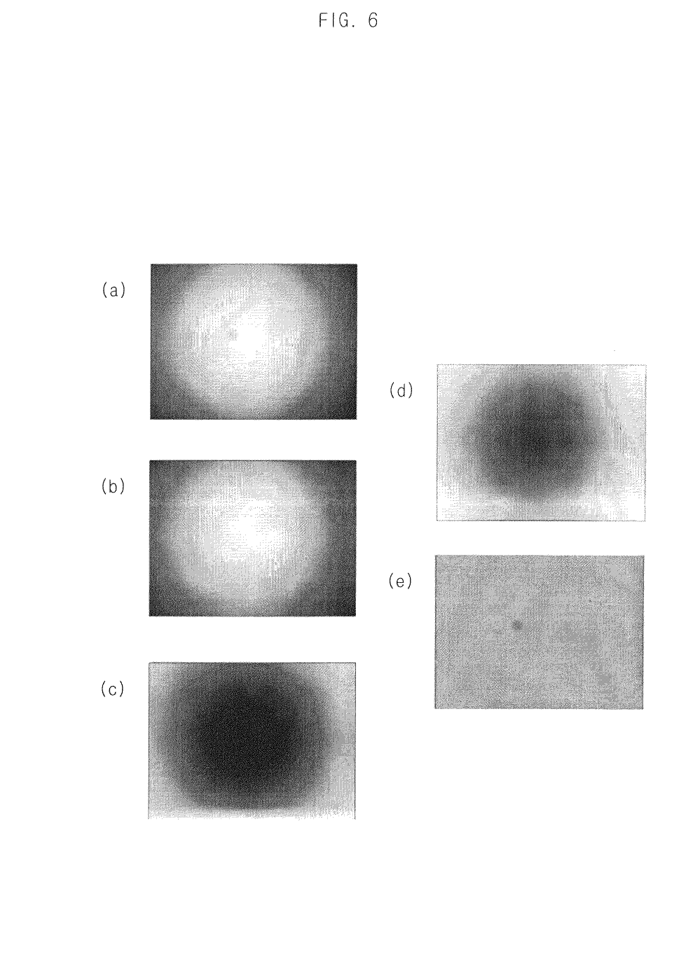

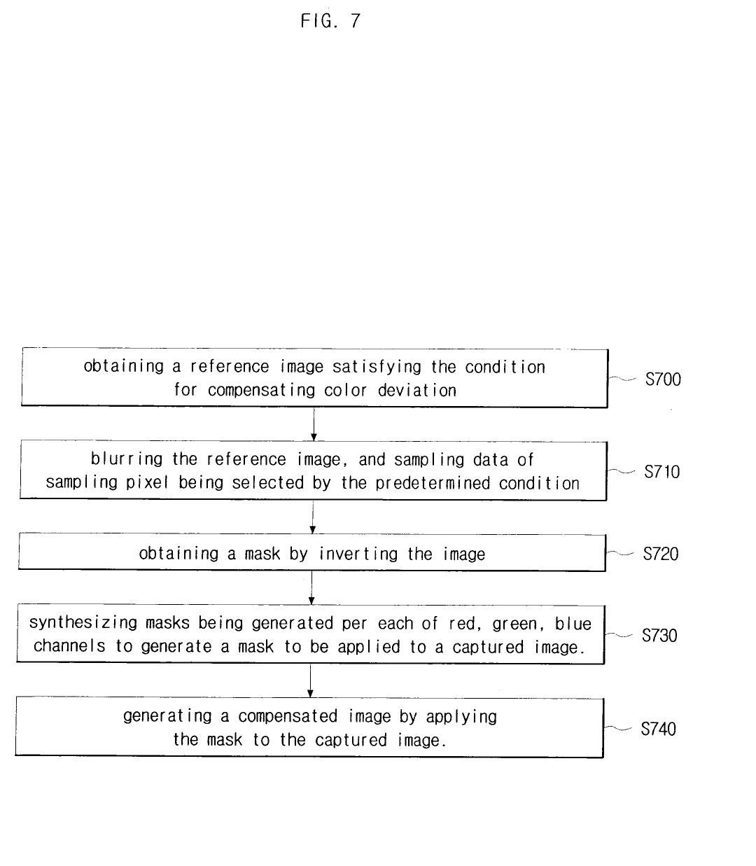

FIG. 6 shows the reference image, mask, and the compensated image according to one embodiment of the present invention, and FIG. 7 is a flowchart showing the method of compensating color deviation.

At step S700, the image analyzer 310 obtains the reference image that satisfies a certain condition for compensating lens distortion (referring to FIG. 6 (a)). For example, an image capturing white surface is obtained. Assume that the reference image is entirely irregular and distorted colored.

At step S710, the image analyzer 310 performs blurring on the reference image, and performs sampling of data of the selected sampling pixel according to the predetermined condition. And, the image analyzer 310 generates data of all pixels of the reference image by varying weights based on the distance from the sampling pixel and generates image thereof (referring to FIG. 6 (b)).

At step S720, the mask generator 320 obtains the mask by inverting the image (referring to FIG. 6 (c)). And, if necessary, by performing a level down to 0 level or multiplying gain, the practically applicable mask is generated.

At step S730, by simultaneously synthesizing masks that are generated per each channel of red, green, and blue to generate the mask to be applied to the captured image (referring to FIG. 6 (d)). The mask is applied to each pixel one by one.

After generating mask, the mask that the mask generator 320 already generated is applied to the captured image from the image sensor.

At step S740, the mask applier 330 applies the mask to the captured image and generates the compensated image that is made by reciprocal multiplication, division, addition, etc., and data overflow, data underflow, etc, (referring to FIG. 6 (e)). When examining the compensated image, it can be seen that the entirely irregular color becomes regular, and there is no difference in luminance between the center portion and the circumference.

In addition, the method of compensating color deviation according to another embodiment of the present invention, it is also possible to generate the mask without the step S710 of generating image, by inverting data of sampling pixels at step S720 and applying the inverted value and weights based on the distance.

In addition, according to the present invention, in order to compensate the lens distortion (irregular color deviation, luminance difference between the center and the circumference, etc), a computer-readable medium including a program containing computer-executable instructions for performing the aforementioned steps S700 to S740 compensates the lens distortion.

As described above, the color deviation compensating apparatus and the method thereof, the image processor using the method, and the recording medium can compensate the all distortions such as white balance, irregular color deviation, etc., occurred by the micro lens of the image sensor.

Also, it is advantageous to compensate the color deviation irregularly and partly appearing on the entire image without a certain pattern.

Although the present invention is described with reference of the preferred embodiments, those who skilled in the art will understand that many changes and equivalent embodiments can be made without departing from the spirits and scope of the present invention.

1. A color deviation compensating apparatus, comprising:
an image analyzer, configured to receive a reference image, divide the reference image into n regions, and perform sampling on data of at least one sampling pixel from each of the regions, wherein n is a natural number, and
a mask generator, configured to generate a mask for compensation based on the sampling data from the image analyzer.

2. The color deviation compensating apparatus of claim 1 further comprising:
an image input device, configured to receive a captured image being captured by the image sensor;
a mask applier, configured to apply the mask from the mask generator to the captured image; and
an image output device, configured to output a compensated image which the mask is applied to.

3. The color deviation compensating apparatus of claim 2, in which the mask applier is configured to apply the mask after eliminating an offset from the mask or converting the mask with a predetermined compensation ratio.

4. The color deviation compensating apparatus of claim 1, in which the image analyzer is configured to select at least one pixel among pixels locating on the boundary of each of the regions as the sampling pixel.

5. The color deviation compensating apparatus of claim 1, in which the mask generator is configured to determine the mask value of pixels in each of the regions based on a locational relationship with the sampling pixels.

6. The color deviation compensating apparatus of claim 1, in which the image analyzer is configured to divide each of the regions by block of a rectangular shape and select pixels corresponding to vortex of the block as sampling pixels.

7. The color deviation compensating apparatus of claim 6, in which the mask generator is configured to apply weights on pixels in the block based on distances from each of the vortexes of the block to determine the mask value.

8. The color deviation compensating apparatus of claim 1, in which the data of sampling pixels is RGB data of the pixels, and a mask value of the mask is obtained from inverting the RGB data.

9. The color deviation compensating apparatus of claim 8, in which the data of the sampling pixels is RGB data in one of red (R), green (G), and blue (B) channels.

10. The color deviation compensating apparatus of claim 1, in which the data of the sampling pixels is a deviation for RGB data of a reference pixel.

11. An image processor of compensating a color deviation, comprising:
a color deviation compensator, configured to divide a reference image into n regions, perform sampling on data of at least one sampling pixel from each of the regions, generate a mask for compensating a captured image based on the sampling data, and generate a compensated image by applying the mask to the captured image, wherein n is a natural number; and
a backend processor, configured to process the compensated image from the color deviation compensator to be displayed.

12. The image processor of claim 11 further comprising an interpolator, configured to perform a color interpolation process on the reference image and generate images of each channel of red, green, and blue to provide to the color deviation compensator.

13. The image processor of claim 11, in which the color deviation compensator comprises:
an image input device, configured to receive a captured image being captured by an image sensor;
an image analyzer, configured to receive the reference image, divide the reference image into n regions, and perform sampling on data of at least one sampling pixel from each of the regions;
a mask generator, configured to generate the mask for compensation based on the sampling data from the image analyzer;
a mask applier, configured to apply the mask from the mask generator to the captured image; and
a compensated image output device, configured to output the compensated image where the mask is applied to.

14. The image processor of claim 13, in which the image analyzer is configured to select at least one pixel among pixels locating on the boundary of each of the regions as the sampling pixel.

15. The image processor of claim 13, in which the mask generator is configured to determine the mask value of pixels in each of the regions based on a locational relationship with the sampling pixels.

16. The image processor of claim 13, in which the image analyzer is configured to divide each of the regions by block of a rectangular shape and select pixels corresponding to vortex of the block as sampling pixels.

17. The image processor of claim 16, in which the mask generator is configured to apply weights on pixels in the block based on distances from each of the vortexes of the block to determine the mask value.

18. The image processor of in which the data of sampling pixels is RGB data of the pixels, and a mask value of the mask is obtained from inverting the RGB data.

19. The image processor of claim 18, in which the data of the sampling pixels is RGB data in one of red (R), green (G), and blue (B) channels.

20. The image processor of claim 11, in which the data of the sampling pixels is a deviation for RGB data of a reference pixel.

21. The image processor of claim 13, in which the mask applier is configured to apply the mask after eliminating an offset from the mask or converting the mask with a predetermined compensation ratio.

22. A method of compensating a color deviation caused by an image sensor, comprising:
(a) obtaining a reference image;
(b) dividing the reference image into 11 regions, wherein n is a natural number;
(c) selecting data of sampling pixels being selected from each the regions according to a predetermined condition; and
(d) generating a mask based on the data of the selected sampling pixels,
wherein the (d) determines a mask value of pixels in each of the regions according to a locational relationship with the sampling pixels.

23. The method of claim 22 further comprising:
(e) obtaining a compensated image that is generated by applying the mask to a captured image.

24. The method of claim 22, in which the (c) selects sampling pixels among pixels locating on the boundary of each of the regions.

25. The method of claim 22, in which the (d) comprises:
(d-1) inverting the data of the sampling pixel; and
(d-2) generating a mask value of all pixels in the region based on the inverted value according to a distance from the sampling pixel.

26. The method of claim 22, in which the (d) comprises:
(d-1) generating pixels data of all pixels in the region based on the data of sampling pixel according to a distance from the sampling pixel; and
(d-2) inverting the pixel data to obtain a mask value.

27. The method of claim 22, in which the (d) divides each of the regions by block of a rectangular shape and the (c) selects pixels corresponding to vortex of the block as sampling pixels.

28. The method of claim 27, in which the (d) apply weights on pixels in the block based on distances from each of the vortexes of the block to determine the mask value.

29. A computer-readable medium including a program containing computer-executable instructions for compensating lens distortion of Hi image sensor, performing the method of compensating color deviation, wherein the method comprising:
(a) obtaining a reference image;
(b) dividing the reference image into n regions, wherein n is a natural number;
(c) selecting data of sampling pixels being selected from each the regions according to a predetermined condition; and
(d) generating a mask based on the data of the selected sampling pixels.
wherein the (d) determines a mask value of pixels in each of the regions according to a locational relationship with the sampling pixels.
